(19) United States
(12) Patent Application Publication
(10) Pub. No.: US 2007/0146670 A1
(43) Pub. Date: Jun. 28, 2007

(54) Lithographic apparatus, patterning device and device manufacturing method

(75) Inventor: Stefan Geerte Kruijswijk, Eindhoven (NL)

Correspondence Address: PILLSBURY WINTHROP SHAW PITTMAN, LLP, P.O. BOX 10500, MCLEAN, VA, 22102, US

(73) Assignee: ASML Netherlands B.V., Veldhoven (NL)

(21) Appl. No.: 11/317,244

(22) Filed: Dec. 27, 2005

(51) Int. Cl. G03B 27/52

(52) U.S. Cl. 355/55; 355/53

(57) ABSTRACT

A lithographic apparatus arranged to transfer a pattern from a patterning device onto a substrate. The lithographic apparatus is provided with an alignment system for aligning the patterning device with the substrate. The patterning device includes a proximity mark with a number of adjacent proximity structures, each proximity structure including a space structure, a reference structure, and a test structure. The reference structure includes a first number of lines at a reference pitch, and the test structure includes a second number of lines at a test pitch. The patterning device may be used to perform proximity matching using the alignment system, or to perform further quality measurements, such as dose-to-size.

### 1. FIELD

The present invention relates to a lithographic apparatus, a patterning device and a method for manufacturing a device.

### 2. BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

A method and apparatus for imaging a mask pattern on a substrate is known from U.S. Pat. No. 5,674,650. The mask pattern comprises the usual alignment marks, but also a number of test marks. The test mark comprises alternating transparent and opaque strips with a periodicity comparable to the period of the normal alignment mark. One half of the strips, e.g. the transparent strips are further subdivided, and each comprise one half width stripe and a number of further subdivided alternating transparent and opaque strips. The period of the subdivided strips is described as being substantially equal to one and a half times the resolving power of the projection lens system of the associated lithographic apparatus. The alignment device of the lithographic apparatus is also used to image the test marks. Due to their small period, the sub-strips cannot be detected separately. This causes an offset in the alignment signal, which is used to find the best focus of the projection beam. When the projection beam is defocused, the images of the subdivided strips will become vaguer, and the latent image of the test mark becomes more symmetrical, resulting in a lower offset.

This known method and apparatus, however, can not be used for qualification and calibration of proximity matching. A chip layout as to be exposed by a lithographic exposure-tool generally consists of multiple structures (isolated lines, dense lines, semi-dense lines) that need to be exposed at the same time (in the same flash). When doing so the line-width of these different structures will have slight offsets relative to each other due to the lithographic physics. These offsets are generally prevented by taking them into account in the reticle design (with opposite sign), such that the image in resist has the correct line-width. The accuracy that can be achieved by this compensating-in-the-reticle-technique is limited by the stability that the offsets have over time, and the level of similarity between exposure-tools that are used to print the same reticle. This accuracy is generally referred to as ‘proximity matching specification’ of the exposure tool.

Qualification of the proximity matching specification is generally done by SEM-measurement of multiple structures. SEM measurement are used for qualification and have several disadvantages: The measurement time is long (several hours), SEM tools have tool offsets that vary from tool-to-tool, SEM tools are expensive for which reason long measurement time is not economically feasible in a lithographic factory. From economically availability limitation, SEM measurements are not suitable for measuring a large amount of structures, to achieve a good qualification of the exposure tool parameter offsets. Even if such extensive qualification will be done, the turn around time is too long to allow a tool calibration by such method to fit in a normal setup- or maintenance sequence.

### 3. SUMMARY

It is desirable to provide a method for proximity matching qualification, and a lithography apparatus suitable for such a method, which do not have the disadvantages of the SEM based method described above.

According to an aspect of the invention, there is provided a lithographic apparatus arranged to transfer a pattern from a patterning device onto a substrate, wherein the lithographic apparatus is further provided with an alignment system for aligning the patterning device with the substrate, and in which the patterning device comprises at least one proximity mark having a predetermined number of adjacent proximity structures, each proximity structure comprising a space structure, a reference structure, and a test structure, in which the reference structure comprises a first number of lines at a reference pitch, and the test structure comprises a second number of lines at a test pitch.

According to a further aspect of the present invention, there is provided a patterning device for use in a lithographic apparatus, the patterning device comprising at least one proximity mark having a predetermined number of adjacent proximity structures, each proximity structure comprising a space structure, a reference structure, and a test structure, wherein the reference structure comprises a first number of lines at a reference pitch, and the test structure comprises a second number of lines at a test pitch.

According to an even further aspect of the present invention, there is provided a device manufacturing method comprising transferring a pattern from a patterning device onto a substrate, wherein proximity matching is performed using a patterning device having at least one proximity mark having a predetermined number of adjacent proximity structures, each proximity structure comprising a space structure, a reference structure, and a test structure, wherein the reference structure comprises a first number of lines at a reference pitch, and the test structure comprises a second number of lines at a test pitch, an alignment system is used to measure an alignment offset between the patterning device and the substrate, and a proximity matching parameter is determined from the measured alignment offset.

### 4. BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 shows a schematic diagram of a conventionally used alignment mark;

FIG. 3 shows a schematic diagram of a proximity mark according to an embodiment of the present invention;

FIG. 4 shows the image of the proximity mark of FIG. 3, the image perceived by the alignment sensor and the alignment offset signal for three possible situations;

FIG. 5 shows a schematic diagram of a further mark having end bars and the resulting image on the substrate after exposure with the proximity mark of FIG. 3 and the further mark;

FIG. 6 shows a schematic diagram of a further embodiment of the proximity mark of the present invention;

FIG. 7 shows a schematic diagram of a further embodiment of the proximity mark of the present invention allowing dose-t-size measurements;

FIG. 8 shows a typical lay-out of a patterning device according to a further embodiment of the present invention;

FIG. 9 shows a detailed view of one of the application areas of the patterning device of FIG. 8;

FIG. 10 shows a lay-out plan of one of the test boxes shown in FIG. 9; and

FIG. 11 shows a plan view of an exposed substrate according to an embodiment of the method according to the present invention.

### 5. DETAILED DESCRIPTION

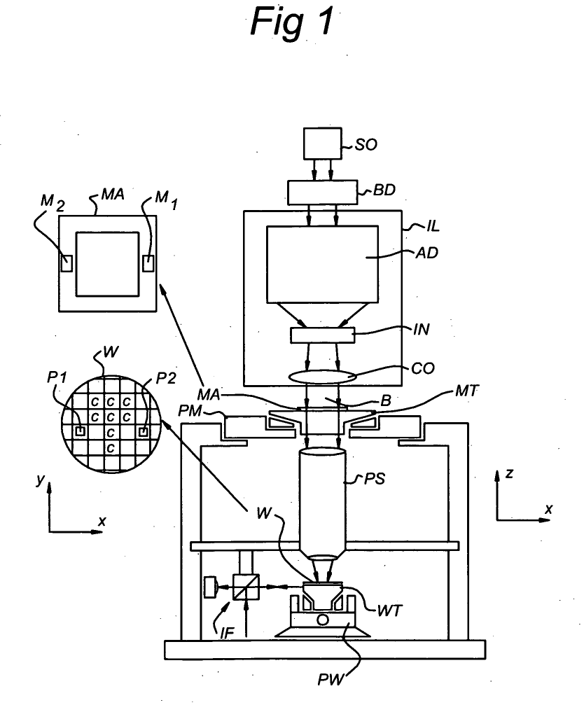

FIG. 1 schematically depicts a lithographic apparatus according to one embodiment of the invention. The apparatus comprises:

an illumination system (illuminator) IL configured to condition a radiation beam B (e.g. UV radiation or other radiation).

a support structure (e.g. a mask table) MT constructed to support a patterning device (e.g. a mask) MA and connected to a first positioner PM configured to accurately position the patterning device in accordance with certain parameters;

a substrate table (e.g. a wafer table) WT constructed to hold a substrate (e.g. a resist-coated wafer) W and connected to a second positioner PW configured to accurately position the substrate in accordance with certain parameters; and

a projection system (e.g. a refractive projection lens system) PS configured to project a pattern imparted to the radiation beam B by patterning device MA onto a target portion C (e.g. comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure supports, i.e. bears the weight of, the patterning device. It holds the patterning device in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may comprise an adjuster AD for adjusting the angular intensity distribution of the radiation beam. Generally, at least the outer and/or inner radial extent (commonly referred to as ρ-outer and ρ-inner, respectively) of the intensity distribution in a pupil plane of the illuminator can be adjusted. In addition, the illuminator IL may comprise various other components, such as an integrator IN and a condenser CO. The illuminator may be used to condition the radiation beam, to have a desired uniformity and intensity distribution in its cross-section.

The radiation beam B is incident on the patterning device (e.g., mask MA), which is held on the support structure (e.g., mask table MT), and is patterned by the patterning device. Having traversed the mask MA, the radiation beam B passes through the projection system PS, which focuses the beam onto a target portion C of the substrate W. With the aid of the second positioner PW and position sensor IF (e.g. an interferometric device, linear encoder or capacitive sensor), the substrate table WT can be moved accurately, e.g. so as to position different target portions C in the path of the radiation beam B. Similarly, the first positioner PM and another position sensor (which is not explicitly depicted in FIG. 1) can be used to accurately position the mask MA with respect to the path of the radiation beam B, e.g. after mechanical retrieval from a mask library, or during a scan. In general, movement of the mask table MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

The depicted apparatus could be used in at least one of the following modes:

1. In step mode, the mask table MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the mask table MT and the substrate table WT are scanned synchronously while a pattern imparted to the radiation beam is projected onto a target portion C (i.e. a single dynamic exposure). The velocity and direction of the substrate table WT relative to the mask table MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

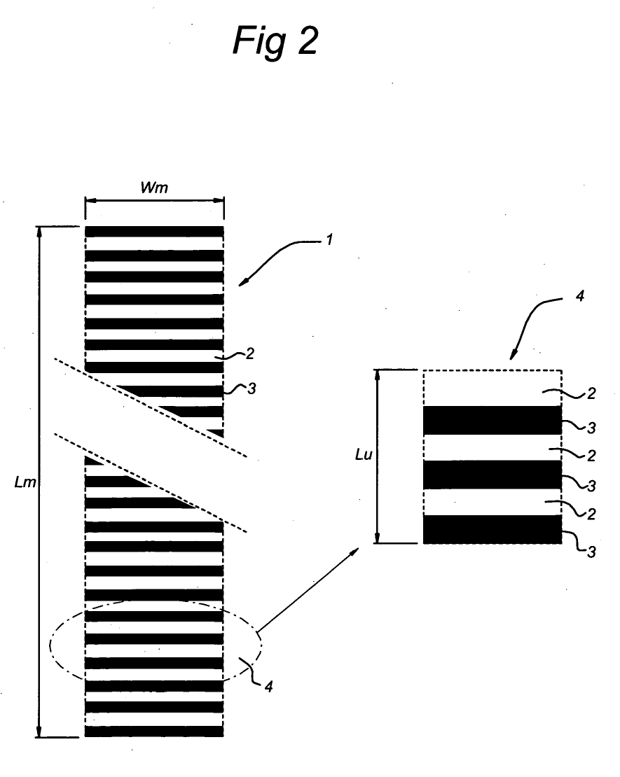

In FIG. 2, a schematic diagram is shown of a conventionally used alignment mark 1. The alignment mark has a length Lₘ much longer than its width Wₘ, and comprises a large number of alternating spaces 2 and lines 3. The period of the alignment mark 1 is defined as the length of a single space 2 and neighbouring line 3, and is e.g. 16 μm/3 to obtain a third order alignment mark 1. A unit cell 4 is defined as three pairs of spaces 2 and lines 3.

An alignment device is a component of the apparatus depicted in FIG. 1, and is used to align the mask MA and wafer W properly for every exposure step of the wafer W. The alignment mark 1 is used in a conventional manner on the mask MA, and is used to project an image on the wafer W. The latent image on the wafer is then e.g. measured by the alignment system to obtain an alignment signal.

A chip layout as to be exposed by a lithographic exposure-tool generally consists of multiple structures (isolated lines, dense lines, semi-dense lines) that need to be exposed at the same time (in the same flash). When doing so the line width of these different structures will have slight offsets relative to each other due to the lithographic physics. These offsets are generally prevented by taking them into account in the reticle design (with opposite sign), such that the image in resist has the correct line-width. The accuracy that can be achieved by this compensating-in-the-reticle-technique is limited by the stability that the offsets have over time, and the level of similarity between exposure tools that are used to print the same reticle. This accuracy is generally be referred to as ‘proximity matching specification’ of the exposure tool.

The line width of these structures of interest corresponds substantially to the critical dimension (CD) of the lithographic apparatus used. The CD is a parameter which is dictated by the characteristics of various components of the lithographic apparatus.

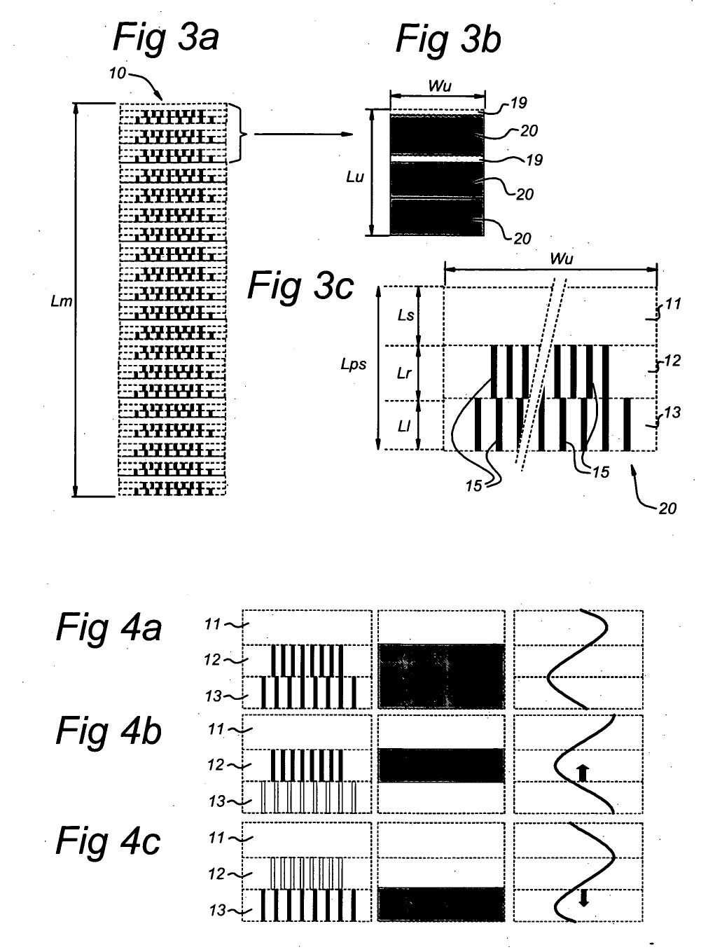

For the proximity matching specification, a normal alignment mark can not be used. According to an embodiment of the present invention, another type of mark, referred to below as proximity mark 10, is used to measure proximity matching. An example of such a proximity mark 10 is shown schematically in FIG. 3. In the proximity mark 10 according to the present invention, ‘balancing’ is introduced, as two structures are compared relative to each other. The position of this proximity mark 10 is measured resulting in a measured overlay value. The measured overlay value shall be equal to a predefined target value that is equal for all machines in a semiconductor production fab. A practical source for this target value could be the first lithographic apparatus that has been installed in such a fab, alternatively some theoretical value may be used. Also, the overlay sensitivity is expected to be relatively well defined, not depending on machine or process. By this approach, an absolute measurement is anticipated to be achieved.

FIG. 3a shows the lay-out of a proximity mark 10, which in general has the same length Lₘ as a conventional alignment mark 1. For reasons of clarity, only a limited number of periodic parts is illustrated in FIG. 3a, in an actual proximity mark 10, the number of periodic parts is much larger. In FIG. 3b, a more detailed view is given of a unit cell 4, of which the length Lᵤ and width Wᵤ correspond substantially to the dimensions of a unit cell 4 in a conventional alignment mark 1. However, instead of the spaces 2 and lines 3 of the alignment mark 1, the proximity mark comprises three proximity structures 20. In order to meet the length requirement of the unit cell 4, also, spaces 19 may be provided between some or all of the proximity structures 20.

FIG. 3c shows a schematic view of a proximity structure 20 as used in the embodiment of the present invention. The proximity structure 20 is subdivided in three parts: a space structure 11, a reference structure 12, and a test structure 13. The width Wᵤ of each of the structures 11, 12, 13 is the same as the width of the unit cell 4 (and the proximity mark 10). In the lengthwise direction of the unit cell 4 (or proximity mark 10), the space structure 11, reference structure 12, and test structure 13 each have an associated length Lₛ, Lᵣ, and L₁, respectively. The space structure 11 is a transparent field, while the reference structure 12 and test structure 13 are provided with opaque lines 15. The opaque lines 15 have a length corresponding to the respective structure lengths Lᵣ, L₁, and a width which is substantially equal to the Critical Dimension (CD) of the lithographic apparatus for which the proximity matching is to be performed, i.e. the lines 15 correspond in general to the structure of interest to be imaged by the lithographic apparatus.

In an exemplary embodiment, the proximity mark 20 is proposed as having a 5.2 μm period having ⅔ (Lᵣ+L₁=3.6 um) lines and ⅓ (Lₛ=1.4 um) spaces. The reference structure 12 is provided with 10 lines having a reference pitch, and the test structure 13 is provided with 10 lines having a ‘pitch-to-be-measured’. A conventional 3^{rd} order scribelane alignment mark (see FIG. 2) is 312 μm×72 μm. Such an alignment mark 1 normally has 60 pairs of a space 2 and line 3. The alignment system of the lithographic apparatus in this case, is capable of measuring the phase of the 5.33 μm period.

In the exemplary embodiment, the lengths of the space structure 11, reference structure 12 and test structure 13 are divided in 40%; 30%; 30%, respectively. Other divisions are possible, e.g. 60%; 20%; 20%. The pitch of the lines 15 in the reference structure 12 and test structure 13 does not influence the alignment sensor because the grating of lines 15 is perpendicular to the alignment bars (as formed by each of the space structure 11, reference structure 12 and test structure 13).

The alignment system will measure a phase which depends on the ‘relative grayness’ of each of the three structures 11, 12, 13 as shown in FIG. 4. In FIG. 4a on the left side, the image of the proximity mark 10 on the wafer is shown under optimal conditions (both the reference structure 12 and test structure 13 are correctly imaged). The alignment sensor will see two equally gray bars (middle picture), as the density (number of lines 15 times the width of the lines 15) is equal for both the reference structure 12 and test structure 13. This results in the measured alignment shift signal as given in the right side of FIG. 4a.

Since both structures 12, 13 in the ⅔ line of the proximity mark 10 have an equal amount of lines 15, the center of gravity for the line will be in the middle of the two structures 12, 13 if both CD's are equal. However, if a CD difference exists between the two structures 12, 13 this will show up as an alignment error as shown in the right side of FIG. 4.

A +/−16.6% phase-shift will be measured when one of the structures 12, 13 vanishes completely. This is depicted in FIG. 4b for the case that the test structure 13 is not imaged at all on the wafer W (and hence, the alignment sensor only sees a gray bar for the middle structure 12). In FIG. 4c, the other extreme situation is given, for the case that the reference structure 12 is not imaged correctly (and hence, the alignment sensor only sees a gray bar for the test structure 13). For the above given exemplary embodiment, a 0.166% phase-shift=8 nm@5.2 μm period is expected from a 1% change in grayness, corresponding to a 1% CD-change. A 1% CD-change is well below the required accuracy (1 nm @100 nm), 8 nm is well within alignment measurement capability (1 nm), so accuracy is anticipated to be sufficient. The CD error to grayness relation is in 1^{st} order approximation a linear relation with analytically known slope. In reality a non-linear component will be present, and the slope will most likely be different, but it seems fair to assume that because of this fundamental relation, machine-to-machine difference will be low. It is anticipated that the described method will allow not only qualitative measurements, but even quantitative measurements.

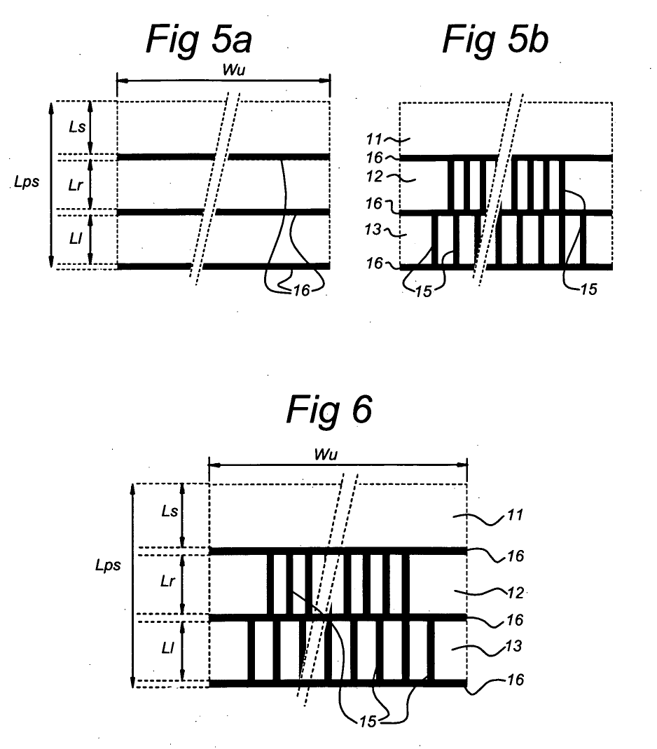

The edges or ends of the lines 15 in each of the structures 12, 13 may result in uncontrolled line-shortening effects in the image of the proximity mark 10. To eliminate the possible disturbances in the measurement results, the image of the proximity mark 10 may be enhanced. A first embodiment is shown in FIG. 5a. After exposure of the wafer W with the proximity mark 10 (e.g. the embodiment shown in FIG. 3c), a secondary proximity mark 10 is used having the configuration as shown in FIG. 5a. At the borders of the space structure 11, reference structure 12 and test structure 13, additional lines 16 are given, spanning the complete width Wu of the proximity mark 10. After the second exposure, the image as shown in FIG. 5b results. The lines 16 are masking the end locations of the lines 15, and as a result, no disturbances from end line effects remain. The ⅓ period will not influence the overlay measurement, and will therefore not influence the result.

In an alternative embodiment, the proximity mark 10 is already provided with the additional lines 16 at the borders between space structure 11, reference structure 12 and test structure 13. This embodiment is shown schematically in FIG. 6.

A best focus for the lithographic apparatus used may be measured by printing the proximity mark 10 at several focus levels of the lithographic apparatus. Since focus has a typical quadratic relation to CD, best focus may be calculated from the results. A number of measurements have revealed that dense line structures cannot be used to find best focus, isolated line structures can very well be used to find best focus, and iso-dense bias structures can also very well be used to find best focus. Since the approach as described with reference to the above embodiments directly measures the iso-dense bias structure, best focus will be easily found when the proximity mark 10 is printed on several focus levels.

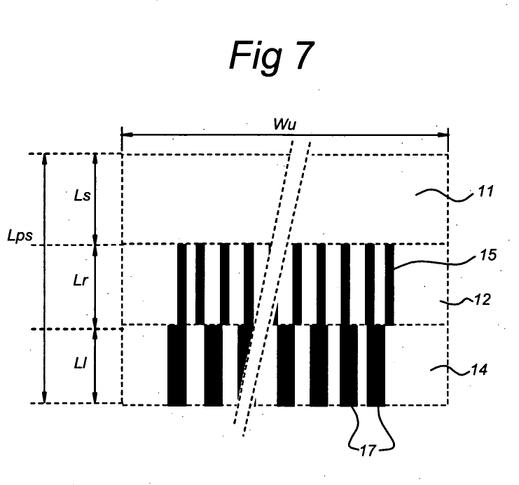

Another operational parameter of a lithographic apparatus is the exposure dose. True proximity matching (as described above) does not target at best energy (being the energy in the middle of the process window), but e.g. at dose-to-size (being the dose required to print exactly the wanted CD). For this, a test structure as shown in FIG. 7 is provided. Instead of the test structure 13 of the proximity structure 20, in this embodiment a dose structure or dose test structure 14 is provided. The dose structure 14 has the same dimensions as the test structure 13, however, instead of lines 15 at the critical dimension, wider lines 17 are being used. In an exemplary embodiment, e.g. the reference structure 12 comprises 50 dense lines 17 at the critical dimension of interest (e.g. 80 nm), and the dose structure 13 comprises 10 dense lines 17 at five times the CD of interest (e.g. 400 nm wide lines 17). Both structures 12, 14 have exactly the same ‘grayness’, so 0 nm overlay is measured nominally. If a dose error is present, the reference structure 12 will be influenced approximately 5 times more than the dose structure 14, so the CD error will translate to an alignment error. The sensitivity is expected to be 80% times the sensitivity for the proximity mark=80%×11 nm_overlay/nm_cd=9 nm_overlay/nm_cd.

This technique has the potential to achieve an absolute CD measurement. In a further embodiment, a SEM measurement is used to calibrate the overlay shift to absolute CD relation.

A standard 3^{rd} order alignment mark 1 as depicted in FIG. 2 has 60 periods. So, already a single mark scan will average over 60 printed features. Also, the ‘average width’ of each 1.8 μm line 3 is measured. The conventional manner of performing proximity matching qualification is using a scanning electron microscope (SEM) on an exposed wafer section. SEM will perform a local cross section analysis and for that reason the measurement result will suffer from line roughness. It seems fair to state that probably 100× less alignment scans are required when compared to the SEM. Typical SEM time is 8 sec/scan, typical alignment scan time is 0.2 s/scan, which is a 40× improvement. For that reason, the proximity matching qualification test according to the present invention is expected to be intrinsically 100×40=4000× faster as a SEM method. This would indicate a reduction of 1 hour SEM time to 1 sec alignment scan time. In practice this means that in 1 minute of measuring by this new method 30× more structures can be measured when compared to typically 2 hours of measuring by SEM. A calibration test for proximity matching is anticipated because of the improved measuring time and enlarged amount of structures to be measured. Since currently no such test is available and proximity matching capability relies on machine tolerances only, this is a major benefit.

The above described measurement methods are much faster than conventional measurement methods for proximity matching, focus test and dose to size tests. In a further embodiment, it is shown that this measurement technique allows a calibration test of a lithographic apparatus. As an example, 20 to 25 different proximity structures 20 may be measured. The correlation of several machine parameters such as sigma inner, sigma outer, numerical aperture NA and laser bandwidth to line width of each of these structures 20 is known. A least-squares algorithm may be used to calculate an optimal offset for each of these parameters to minimize the measured proximity effects. These offsets are then applied as calibration offsets.

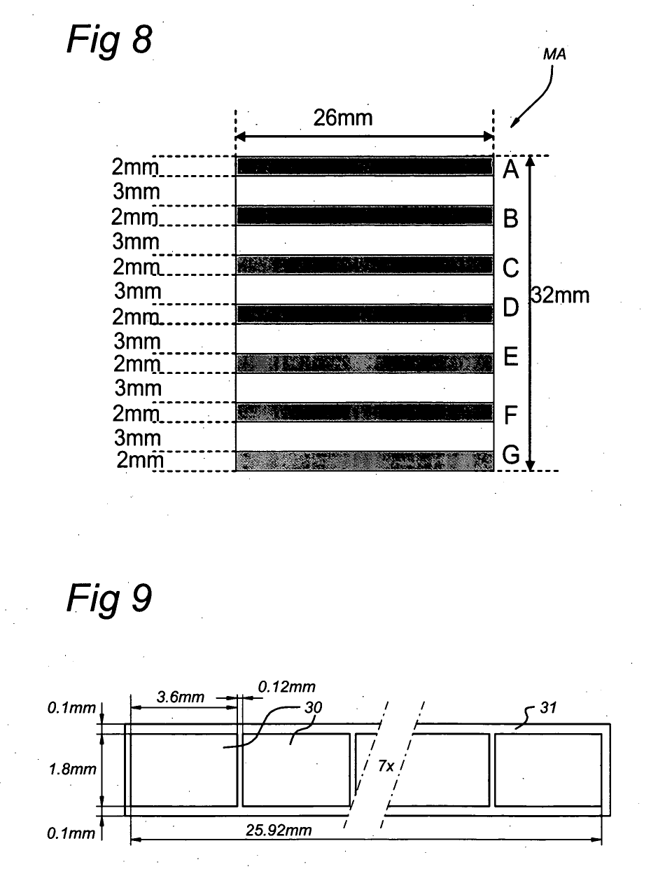

In a further embodiment, a full proximity qualification test is executed. In the following example, sizes and numbers have been chosen to present the idea. However, all of these sizes and numbers may be amended for specific uses. An embodiment of a mask MA with 7 application-area's A-G of 2 mm×26 mm, separated by 3 mm chrome is shown in FIG. 8. In application area A, test structures for a critical dimension of 130 nm are present. In the application areas B-F, test structures for a critical dimension of 110 nm, 90 nm, 80 nm, 65 nm, 50 nm, respectively may be provided to span a large area of applications and types of lithographic apparatus. Application area G, finally, is provided with a number of end bar structures (see embodiment of FIG. 5a). Each application area A-G has seven identical 1.8 mm×3.6 mm test boxes 30 as shown in FIG. 9. Each test box 30 is surrounded by some guard area 31 to allow correct spacing. This allows qualification on seven points in the slit.

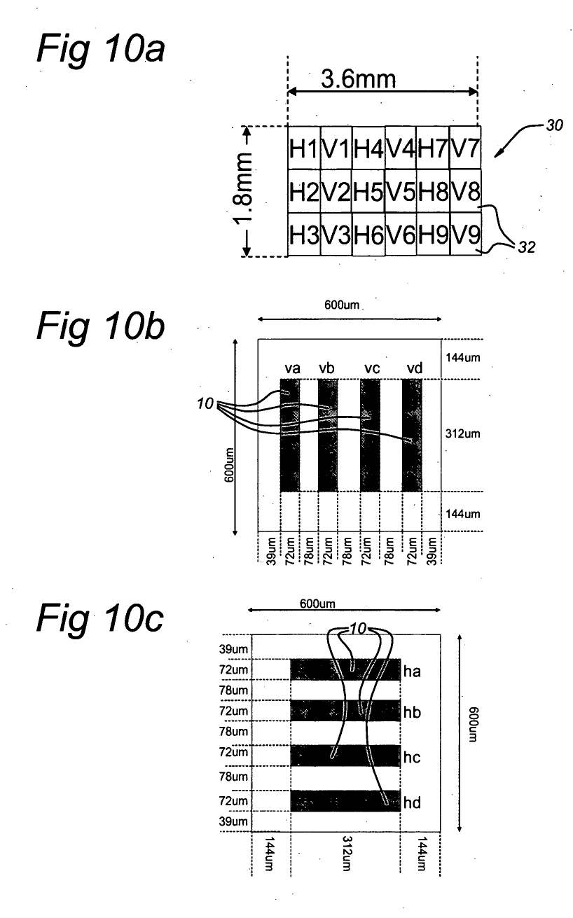

As shown in FIGS. 10a, b and c, each test box 30 has nine quartets 32 (indicated by H1-H9) of horizontal structures ha-hb, and nine quartets 32 (indicated by V1-V9) of vertical structures va-vd, such that a total of 36 horizontal and 36 vertical test structures are available. In the following table, a definition per test structure is given. For the test structures (ha-hd; va-vd), any of the embodiments of the proximity mark 10 shown in FIG. 3, 5, 6, or 7 may be used. The following is included: two alternatives for dose-to-size test: CD< >5CD and CD< >2CD, including reference; twenty proximity structures for pitches of 1:1 until 1:1000; five proximity reference structures on pitches of 1:1, 1:1.3, 1:2, 1:5 and 1:1000. This leaves the eighth and ninth quartets (H8, V8, H9, V9) to be determined for future use.

| Hori- | Verti- | Reference | Test structure | |
|---|---|---|---|---|
| zontal | cal | structure (12) | (13; 14) | Function |
| H1a | V1a | 50× 1:1 @CD | 10× 1:1 @5CD | Dose-to-Size |
| H1b | V1b | 40× 1:1 @CD | 20× 1:1 @2CD | Dose-to-Size |
| H1c | V1c | 50× 1:1 @CD | 50× 1:1 @CD | Dose-to-Size: |
| | | | | reference |
| H1d | V1d | 40× 1:1 @CD | 40× 1:1 @CD | Dose-to-Size: |
| | | | | reference |
| H2a | V2a | 10× 1:1 @CD | 10× 1:1 @CD | Proximity- |
| | | | | Reference |
| H2b | V2b | 10× 1:1 @CD | 10× 1:1.2 @CD | Proximity |
| H2c | V2c | 10× 1:1 @CD | 10× 1:1.3 @CD | Proximity |
| H2d | V2d | 10× 1:1 @CD | 10× 1:1.5 @CD | Proximity |
| H3a | V3a | 10× 1:1 @CD | 10× 1:1.7 @CD | Proximity |
| H3b | V3b | 10× 1:1 @CD | 10× 1:2 @CD | Proximity |
| H3c | V3c | 10× 1:1 @CD | 10× 1:2.4 @CD | Proximity |
| H3d | V3d | 10× 1:1 @CD | 10× 1:2.6 @CD | Proximity |
| H4a | V4a | 10× 1:1 @CD | 10× 1:3 @CD | Proximity |
| H4b | V4b | 10× 1:1 @CD | 10× 1:4 @CD | Proximity |
| H4c | V4c | 10× 1:1 @CD | 10× 1:5 @CD | Proximity |
| H4d | V4d | 10× 1:1 @CD | 10× 1:7 @CD | Proximity |
| H5a | V5a | 10× 1:1 @CD | 10× 1:10 @CD | Proximity |
| H5b | V5b | 10× 1:1 @CD | 10× 1:20 @CD | Proximity |
| H5c | V5c | 10× 1:1 @CD | 10× 1:40 @CD | Proximity |
| H5d | V5d | 10× 1:1 @CD | 10× 1:100 @CD | Proximity |
| H6a | V6a | 10× 1:1 @CD | 10× 1:300 @CD | Proximity |
| H6b | V6b | 10× 1:1 @CD | 10× 1:500 @CD | Proximity |
| H6c | V6c | 10× 1:1 @CD | 10× 1:700 @CD | Proximity |
| H6d | V6d | 10× 1:1 @CD | 10× 1:1000 @CD | Proximity |
| H7a | V7a | 10× 1:1.3 @CD | 10× 1:1.3 @CD | Proximity- |
| | | | | Reference |
| H7b | V7b | 10× 1:2 @CD | 10× 1:2 @CD | Proximity- |
| | | | | Reference |
| H7c | V7c | 10× 1:5 @CD | 10× 1:5 @CD | Proximity- |
| | | | | Reference |
| H7d | V7d | 10× 1:1000 @CD | 10× 1:1000 @CD | Proximity- |
| | | | | Reference |
| H8a | V8a | | | future |
| H8b | V8b | | | future |
| H8c | V8c | | | future |
| H8d | V8d | | | future |
| H9a | V9a | | | future |
| H9b | V9b | | | future |
| H9c | V9c | | | future |
| H9d | V9d | | | future |

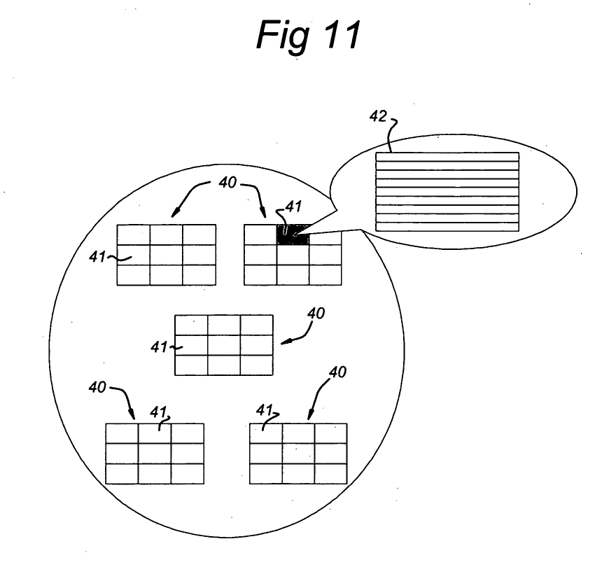

Using this mask MA, each 2 mm×26 mm area is exposed on the wafer W (creating exposed area 42 on the wafer) at nine dose levels to create boxes 41 of 18 mm×26 mm, as shown in FIG. 11. Each of those boxes 41 is exposed at nine focus levels, so a total area 40 on the wafer W of 54 mm×78 mm is covered. Five of these areas 40 should fit on a single wafer W. When necessary, end bar structures (see FIG. 5a) are also exposed on the wafer W.

A first pass readout using the alignment system of the lithographic apparatus is performed. For horizontal and vertical, nine focus-levels, for nine dose-levels, on one test box 30 per field, on the centre of wafer area 40, one dose structure and one dose reference structure is read, as well as one dense and one iso-dense proximity structure. This results in a total of 648 readouts, Then for all focus measurements, the following is calculated:
iso-dense bias(IDB)={position-dense-structure−position-iso-reference}×AlignmentIDBConversion,

AlignmentIDBConversion being a process specific parameter which is determined once for a specific process, e.g. using a comparison of a direct IDB measurement from SEM samples to the alignment measurements.

Best focus (BF)=top of parabolic fit through IDB-numbers.

For all dose measurements at best focus, the dose to size is calculated using:
CD={position-dose-structure−position-dose-reference}×AlignmentCDConversion,

AlignmentCDConversion being a process specific parameter which is determined once for a specific process, e.g. using a comparison of a direct CD measurement from SEM samples to the alignment measurements.

Dose-to-Size=Dose to achieve required CD.

Then a second pass readout using the alignment system is made for horizontal (H1-H9) and vertical (V1-V9), at best focus, at dose to size, on seven test boxes 30 per field, on all five wafer areas 40, and twenty proximity structures are read, resulting in a total of 1400 readouts. For all measurements at best focus, the following is calculated:
IDB={position-proximity-Structure−position-Reference}×AlignmentIDBConversion

Since all measurements are done relative to a reference, readout is completely independent from the readout tool. This method thus achieves a tool-independent qualification of a proximity-wafer.

After Qualification on proximity using the method as described above, IDB is known for twenty proximity-structures. Sensitivity of each of those structures to machine parameters such as NA, sigma-outer, sigma-inner and E95 can easily be calculated using lithographic simulation and/or by experiment. Using a least-square fitting method, adjustments for above machine-parameters can be calculated from the 20 IDB-numbers. After applying these machine-adjustments a verification qualification can be done to confirm that proximity has been calibrated.

By using this method machine- and track are simultaneously calibrated which is an advantage since machines and tracks are always used as a couple.

As described in detail above using a number of exemplary embodiments, the present invention in general provides for a lithographic apparatus, a patterning device and a method as described in the appended independent claims.

In a further embodiment of the patterning device of the present invention, which may be used in a lithographic apparatus according to the present invention, the lines in the reference structure have a width which is substantially equal to a critical dimension of the lithographic apparatus, the critical dimension corresponding to the smallest dimension of a structure of interest to be transferred by the lithographic apparatus onto the substrate. Furthermore, the product of number of lines and line width is the same for both the reference structure and the test structure in a further embodiment, such that an equal gray image is formed for the alignment sensor. Proximity matching measurements may be performed using a further embodiment, wherein the width of the lines in the test structure is substantially equal to the width of the lines in the reference structure, the first number is equal to second number, and the reference pitch is not equal to the test pitch. Using the reference structure and the test structure with a different pitch of the lines, it is possible to use the alignment sensor to see if imaging is still correct for the different pitch by comparing the test structure to the reference structure. In an even further embodiment, which is particularly suited to perform measurements for determining dose to size, the width of the lines in the test structure is an integer times larger than the width of the reference lines (e.g. CD vs. 5 times CD).

The method according to the present invention may be further applied with a patterning device according to the present invention which is provided with a plurality of proximity marks, wherein the lines in the test structures of the plurality of proximity marks are provided with a range of line widths and pitch sizes. A plurality of exposures is performed on the substrate at various focus levels, and a best focus parameter is determined from the measured alignment offsets. In a further embodiment, a plurality of exposures is performed on the substrate at various exposure doses, and a dose-to-size parameter is determined from the measured alignment offsets. These methods may be applied on various locations on a substrate, in order to perform a full qualification of the lithographic apparatus.

More in general, the present invention may use reference structures and/or test structures in the proximity mark which comprise a multiplicity of any structure that is similar to an actual product structure that is imaged during actual use of a lithographic apparatus, e.g. in IC manufacturing.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g. having a wavelength of or about 365, 355, 248, 193, 157 or 126 nm) and extreme ultra-violet (EUV) radiation (e.g. having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

We claim:

1. A lithographic apparatus arranged to transfer a pattern from a patterning device onto a substrate, wherein the lithographic apparatus is further provided with an alignment system for aligning the patterning device with the substrate, and in which the patterning device comprises:
at least one proximity mark having a predetermined number of adjacent proximity structures, each proximity structure comprising:
a space structure,
a reference structure, and
a test structure, in which the reference structure comprises a first number of lines at a reference pitch, and the test structure comprises a second number of lines at a test pitch.

2. The lithographic apparatus of claim 1, wherein the lines in the reference structure have a width which is substantially equal to a critical dimension of the lithographic apparatus, the critical dimension corresponding to the smallest dimension of a structure of interest to be transferred by the lithographic apparatus onto the substrate.

3. The lithographic apparatus of claim 1, wherein the product of number of lines and line width is the same for both the reference structure and the test structure.

4. The lithographic apparatus of claim 1, wherein the lines in the reference structure have a width which is substantially equal to a critical dimension of the lithographic apparatus, the critical dimension corresponding to the smallest dimension of a structure of interest transferred by the lithographic apparatus onto the substrate, wherein the width of the lines in the test structure is substantially equal to the width of the lines in the reference structure, the first number is equal to the second number, and the reference pitch is not equal to the test pitch.

5. The lithographic apparatus of claim 4, wherein the product of number of lines and line width is the same for both the reference structure and the test structure.

6. The lithographic apparatus of claim 1, wherein the lines in the reference structure have a width which is substantially equal to a critical dimension of the lithographic apparatus, the critical dimension corresponding to the smallest dimension of a structure of interest to transferred by the lithographic apparatus onto the substrate, wherein the width of the lines in the test structure is an integer times larger than the width of the lines in the reference structure.

7. The lithographic apparatus of claim 6, wherein the product of number of lines and line width is the same for both the reference structure and the test structure.

8. A patterning device for use in a lithographic apparatus, the patterning device comprising:
at least one proximity mark having a predetermined number of adjacent proximity structures, each proximity structure comprising:
a space structure,
a reference structure, and
a test structure, wherein the reference structure comprises a first number of lines at a reference pitch, and the test structure comprises a second number of lines at a test pitch.

9. The patterning device of claim 8, wherein the lines in the reference structure have a width which is substantially equal to a critical dimension of the lithographic apparatus, the critical dimension corresponding to the smallest dimension of a structure of interest to be transferred by the lithographic apparatus onto the substrate.

10. The patterning device of claim 8, wherein the product of number of lines and line width is the same for both the reference structure and the test structure.

11. The patterning device of claim 8, wherein the lines in the reference structure have a width which is substantially equal to a critical dimension of the lithographic apparatus, the critical dimension corresponding to the smallest dimension of a structure of interest to be transferred by the lithographic apparatus onto the substrate, wherein the width of the lines in the test structure is substantially equal to the width of the lines in the reference structure, the first number is equal to the second number, and the reference pitch is not equal to the test pitch.

12. The patterning device of claim 11, wherein the product of number of lines and line width is the same for both the reference structure and the test structure.

13. The patterning device of claim 8, wherein the lines in the reference structure have a width which is substantially equal to a critical dimension of the lithographic apparatus, the critical dimension corresponding to the smallest dimension of a structure of interest to be transferred by the lithographic apparatus onto the substrate, wherein the width of the lines in the test structure is an integer times larger than the width of the lines in the reference structure.

14. The patterning device of claim 13, wherein the product of number of lines and line width is the same for both the reference structure and the test structure.

15. A device manufacturing method comprising:
transferring a pattern from a patterning device onto a substrate;
performing proximity matching using a patterning device having at least one proximity mark having a predetermined number of adjacent proximity structures, each proximity structure comprising a space structure, a reference structure, and a test structure, wherein the reference structure comprises a first number of lines at a reference pitch, and the test structure comprises a second number of lines at a test pitch,
measuring an alignment offset between the patterning device and the substrate, and
determining a proximity matching parameter from the measured alignment offset.

16. The device manufacturing method of claim 15, wherein the lines in the reference structure have a width which is substantially equal to a critical dimension of a lithographic apparatus used in the device manufacturing method, the critical dimension corresponding to the smallest dimension of a structure of interest to be transferred by the lithographic apparatus onto the substrate.

17. The device manufacturing method of claim 15, wherein the product of number of lines and line width is the same for both the reference structure and the test structure of the proximity mark.

18. The device manufacturing method of claim 15, wherein the lines in the reference structure have a width which is substantially equal to a critical dimension of a lithographic apparatus used in the device manufacturing method, the critical dimension corresponding to the smallest dimension of a structure of interest to be transferred by the lithographic apparatus onto the substrate, wherein the width of the lines in the test structure is substantially equal to the width of the lines in the reference structure, the first number is equal to the second number, and the reference pitch is not equal to the test pitch.

19. The device manufacturing method of claim 18, wherein the product of number of lines and line width is the same for both the reference structure and the test structure.

20. The device manufacturing method of claim 15, wherein the lines in the reference structure have a width which is substantially equal to a critical dimension of a lithographic apparatus used in the device manufacturing method, the critical dimension corresponding to the smallest dimension of a structure of interest to be transferred by the lithographic apparatus onto the substrate, wherein the width of the lines in the test structure is an integer times larger than the width of the lines in the reference structure.

21. The device manufacturing method of claim 20, wherein the product of number of lines and line width is the same for both the reference structure and the test structure.

22. The device manufacturing method of claim 15, wherein the patterning device is provided with a plurality of proximity marks, wherein the lines in the test structures of the plurality of proximity marks are provided with a range of line widths and pitch sizes,
wherein a plurality of exposures is performed on the substrate at various focus levels, a best focus parameter is determined from the measured alignment offsets.

23. The device manufacturing method of claim 15, wherein a plurality of exposures is performed on the substrate at various exposure doses and a dose-to-size parameter is determined from the measured alignment offsets.
